(19) United States
(12) Patent Application Publication
(10) Pub. No.: US 2019/0061032 A1
(43) Pub. Date: Feb. 28, 2019

(54) SYSTEM AND METHOD FOR JOINING STRUCTURES OF DISSIMILAR MATERIAL

(71) Applicant: GM GLOBAL TECHNOLOGY OPERATIONS LLC, Detroit, MI (US)

(72) Inventor: Paul J. Wolcott, Macomb, MI (US)

(73) Assignee: GM GLOBAL TECHNOLOGY OPERATIONS LLC, Detroit, MI (US)

(21) Appl. No.: 15/686,915

(22) Filed: Aug. 25, 2017

(51) Int. Cl. B23K 1/00; B23K 3/047; B23K 3/08; B23K 11/20

(52) U.S. Cl. CPC B23K 1/0004; B23K 3/0478; B23K 2201/006; B23K 11/20; B23K 3/087

(57) ABSTRACT

A system and method for joining structures includes a method of joining a first panel to a second panel. A first workpiece formed of a first material is positioned adjacent a second workpiece formed of a second material and joined with a joining process. At least one welding insert is formed from the joined first and second workpieces having an upper portion formed of the first material and a lower portion formed of the second material. The at least one welding insert is positioned between a first panel formed of the first material and a second panel formed of the second material and placed between first and second electrodes of a welding device. First and second electrodes of the welding device generate an electric current to join the first panel, at least one welding insert, and the second panel.

### INTRODUCTION

The present disclosure relates to a system and method for joining structures of dissimilar materials.

Automotive body panels are typically formed of metals and are joined together by welding. Welding is a manufacturing or fabrication process that bonds materials, such as metals or thermoplastics, by causing coalescence, a process by which two separate units grow together, fuse, or merge into a single body. The materials are joined by liquefying or plasticizing the areas to be bonded together, generally through the application of heat and/or pressure over time, promoting coalescence of the liquefied or plasticized material, and allowing the coalesced material to cool, thereby solidifying the bond.

Spot welding using electrical resistance is generally used to join together similar metallic panels with each other. However, when applied to join dissimilar metallic panels, a brittle intermetallic compound is often produced at the joint. Accordingly, the spot welding of dissimilar materials has been traditionally achieved with mechanical fasteners, such as bolts and rivets.

### SUMMARY

A system and method for joining structures includes a method of joining a first panel to a second panel. The method includes positioning a first workpiece formed of a first material adjacent a second workpiece formed of a second material. A joining process is applied to join the first workpiece to the second workpiece. At least one welding insert is prepared from the joined first and second workpieces and includes an upper portion formed of the first material and a lower portion formed of the second material.

The at least one welding insert is positioned between a first panel formed of the first material and a second panel formed of the second material. The upper portion of the at least one welding insert is positioned adjacent the first panel and the lower portion of the at least one welding insert is positioned adjacent the second panel. The first panel, second panel, and at least one welding insert are positioned between first and second electrodes of a welding device such that the first electrode is proximate the first panel and the second electrode is proximate the second panel. The welding device generates an electric current with the first and second electrodes to join the first panel, at least one welding insert, and the second panel. The electric current generates thermal energy having a first temperature that joins the upper portion of the at least one welding insert to the first panel and the lower portion of the at least one welding insert to the second panel to join the first panel with the second panel.

The method includes contacting the first panel with the first electrode and the second panel with the second electrode and applying a force to at least one of the first and second electrodes that is operative to clamp the first panel, at least one welding insert, and second panel between the first and second electrodes. The method includes preparing the at least one welding insert by cutting the joined first and second workpieces into two or more sections.

The first material for use with the first panel and at least one welding insert may be a metal while the second for use with the second panel and at least one welding insert may be a non-metal. Alternatively, the first material may be a first metal and the second material may be second metal distinct from the first metal. In one non-limiting embodiment, the first metal is steel and the second metal is aluminum.

The thermal energy generated between the first and second electrodes of the welding device is generated at a first temperature. The first temperature of the thermal energy generated between the first and second electrodes of the welding device is determined based upon the first and second materials used to form the first panel, the second panel, and the at least one welding insert. The welding device may include resistance spot welding gun. The first and second workpieces may be joined using a solid-state welding process.

In another embodiment, the method includes positioning a first workpiece formed of a first material adjacent a second workpiece formed of a second material. A solid-state welding process is applied to join the first workpiece to the second workpiece. At least one welding insert is prepared from by separating the joined first and second workpieces into two or more sections. The at least one welding insert includes an upper portion formed of the first material and a lower portion formed of the second material.

The at least one welding insert is positioned between a first panel formed of the first material and a second panel formed of the second material to place the upper portion of the at least one welding insert is positioned adjacent the first panel and the lower portion of the at least one welding insert is positioned adjacent the second panel. The first panel, second panel, and at least one welding insert are positioned between first and second electrodes of a welding device such that the first electrode is proximate the first panel and the second electrode is proximate the second panel.

The welding device generates an electric current with the first and second electrodes to join the first panel, at least one welding insert, and the second panel. The electric current generates thermal energy having a first temperature that joins the upper portion of the at least one welding insert to the first panel and the lower portion of the at least one welding insert to the second panel to join the first panel with the second panel.

The method includes contacting the first panel with the first electrode and the second panel with the second electrode and applying a force to at least one of the first and second electrodes that is operative to clamp the first panel, at least one welding insert, and second panel between the first and second electrodes. The thermal energy generated between the first and second electrodes of the welding device is generated at a first temperature. The first temperature of the thermal energy generated between the first and second electrodes of the welding device is determined based upon the first and second materials used to form the first panel, the second panel, and the at least one welding insert.

The method includes preparing the at least one welding insert by cutting the joined first and second workpieces into two or more sections. The first material may be steel and the second metal may be aluminum.

In another embodiment, a system for assembling a structure includes a first panel formed from a first material and a second panel made of a second material. At least one welding insert is positionable between and proximate each of the first panel and the second panel. The at least one welding insert includes an upper portion formed of the first material and a lower portion formed of the second material.

A welding device having at least a first electrode and a second electrode is configured to join the first panel, second panel, and at least one welding insert between the first and second electrodes to bond the first panel with the second panel. The welding device positions the first panel, second panel, and at least one welding insert between the first and second electrodes such that the first electrode is proximate the first panel and the second electrode is proximate the second panel. The welding device contacts the first panel with the first electrode and the second panel with the second electrode and generates an electric current with the first and second electrodes to generate thermal energy having a first temperature that joins the first panel, at least one welding insert, and second panel positioned between the first and second electrodes to bond the first panel with the second panel.

The first and second electrodes are operatively connected to apply a force to the first panel and the second panel when positioned between the first and second electrodes. The thermal energy is generated between the first and second electrodes of the welding device at a first temperature which is determined based upon one or more of the materials used to form the first panel, the second panel, and the adhesive material.

The at least one welding insert is formed by applying a joining process to join the first workpiece to the second workpiece and preparing at least one welding insert by separating the joined first and second workpieces into two or more sections, wherein the at least one welding insert includes an upper portion formed of the first material and a lower portion formed of the second material. The joining process may include a solid-state welding process.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a side elevational view of first and second panels of a structure positioned relative to a welding device in accordance with the disclosure; and

FIG. 2 is a schematic side elevational view of a welding insert formation process;

FIG. 3 is a perspective view of the welding insert; and

FIG. 4 is flowchart detailing the method of joining structures in accordance with the disclosure.

### DETAILED DESCRIPTION

Reference will now be made in detail to several embodiments of the disclosure that are illustrated in the accompanying drawings. Whenever possible, the same or similar reference numerals are used in the drawings and the description to refer to the same or like parts or steps. The drawings are in simplified form and are not to precise scale. For purposes of convenience and clarity, directional terms, such as top, bottom, left, right, up, over, above, below, beneath, rear, and front, may be used with respect to the drawings. These and similar directional terms are not to be construed to limit the scope of the disclosure.

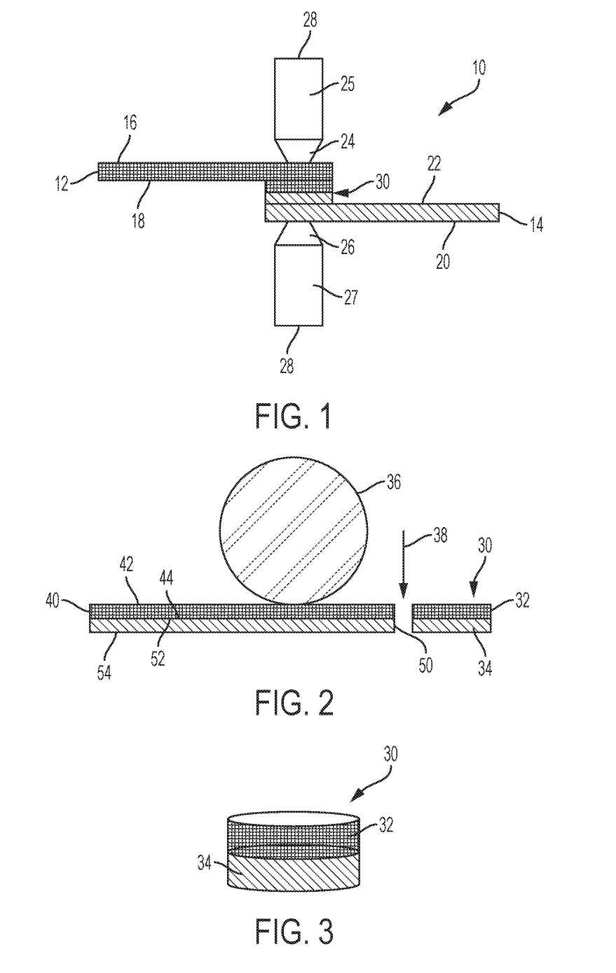

Referring to the drawings, wherein like reference numbers correspond to like or similar components throughout the several Figures, a structure is generally shown at 10. Referring to FIG. 1, the structure 10 is shown in a pre-bonded state and includes a first sheet or panel 12 composed of a first material and a second panel 14 composed of a second material that is operatively connected to the first panel 12. It is understood that the first and second materials of the first panel 12 and second panel 14 may be similar materials, such as both formed from metals or formed from polymers, or may be formed from dissimilar materials. For example, the first panel 12 may formed from aluminum while the second panel 14 may be formed from a distinct metal from the metal selected for the first panel such as steel or the like. In another non-limiting embodiment, the first panel may be formed from metal while the second panel may be formed from a non-metal such as thermoplastics or the like.

In one non-limiting example, the first panel 12 may be formed from an aluminum alloy or the like while the second panel 14 may be formed from steel such as a galvanized low carbon steel or a galvanized high strength steel. It is also contemplated that one or more of the materials may be coated with a conversion coating to improve the adhesive bond performance.

As shown in the Figures, the first and second panels 12, 14 may be vehicle body panels, such as the inner and outer panels of a vehicle door, fender, hood and the like. The panels 12, 14 may be used on a variety of vehicles which may include, but not be limited to, a commercial vehicle, industrial vehicle, passenger vehicle, aircraft, watercraft, train or a mobile platform. It is also contemplated that the vehicle may be a mobile platform, such as an airplane, all-terrain vehicle (ATV), boat, personal movement apparatus, robot, and the like to accomplish the purposes of this disclosure.

The first panel 12 includes an exterior surface 16 and an opposing interior surface 18. The second panel 14 also includes an exterior surface 20 and an opposing interior surface 22. As will be described in greater detail below, it is contemplated that the exterior surfaces 16, 20 of the first and second panels 12, 14 may be engaged by one or more electrodes 24, 26 of a welding device 28. For example, a first electrode 24 may engage the exterior surface 16 of the first panel 12 while a second electrode 26 may engage the exterior surface 20 of the second panel 14.

Referring now to FIG. 2, a process for forming an insert 30 for use in joining the first panel 12 to the second panel 14 of the structure 10 is described in greater detail. Processes for joining similar or dissimilar materials include, but are not limited to, mechanical joining, such as joining with fasteners or the like, solid-state joining, such as ultrasonic welding or friction-stir welding, and adhesive bonding among others. In one non-limiting example, a solid-state joining or welding process may be used to join a first workpiece 40 and a second workpiece 50 with a joining tool, generally represented by numeral 36.

As shown in FIG. 2, the first workpiece 40 includes a first or upper surface 42 and an opposing second or lower surface 44. The second surface 44 of the first workpiece is positioned proximate a first or upper surface 52 of the second workpiece 50 and thereby exposing the second or lower surface 54 of the second workpiece 50. The lower surface 44 of the first workpiece 40 and the upper surface 52 of the second workpiece 50 contact upon joining of the workpieces 40, 50 and are secured to one another.

A joining process may be used to join the first and second workpieces. In one non-limiting embodiment, the joining process may include a solid-state welding process such as ultrasonic metal welding. In ultrasonic metal welding, the ultrasonic energy may create a relative motion between the adjacent surfaces of the first and second workpieces 40, 50. This motion between the workpieces 40, 50 may create a scrubbing-like effect that displaces surface oxides and contaminants, leading to metal to metal contact and bonding to occur.

Upon completion of the solid-state welding process, a portion of the bonded first and second workpieces 40, 50 is separated from the workpieces 40, 50 to create the welding insert 30 with a cutting tool, generally referenced by numeral 38, or the like. As shown in FIG. 3, the welding insert 30 includes a first or upper portion 32 formed of a first material and a second or lower portion 34 formed of a second material that is dissimilar from the first material. The welding insert 30 may be sized to be received between the first and second panels 12, 14 as will be described in greater detail below. It is also understood that the system and method described herein may be used in more than one plane to bond structures. Put another way, the system and method may be used in multiple planes and locations to geo-set parts or structures.

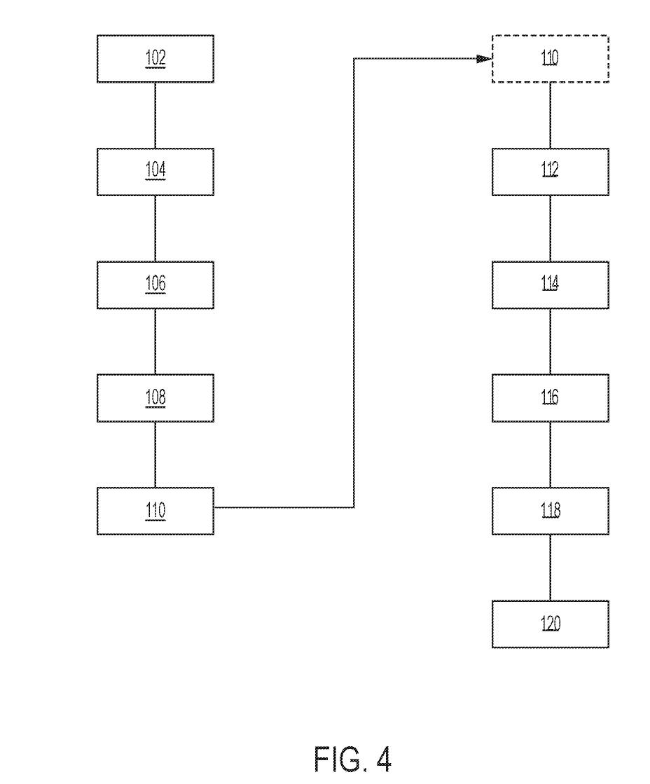

Referring now to FIGS. 1 and 4, a flowchart detailing the method for joining the first panel 12 and second panel 14 formed of dissimilar materials of the structure 10 is described in greater detail. The method need not be applied in the specific order recited herein, and it is further understood that one or more steps may be eliminated. The method begins at box or step 102, wherein the interior or second surface 44 of the first workpiece 40 is positioned proximate to and against the interior or first surface 52 of the second workpiece 50 such that the interior surfaces 44, 52 of the first and second workpieces 40, 50 are engaged.

At step or box 104, pressure may be applied to the first and second workpieces 40, 50 to ensure the workpieces 40, 50 maintain contact with each other once the second or lower surface 44 of the first workpiece 40 is positioned proximate a first or upper surface 52 of the second workpiece 50. At step or box 106, a joining process is applied to the first and second workpieces 40, 50 to join the workpieces 40, 50 and create a unitary structure.

The joining process may be a solid-state welding process used to join the first and second workpieces 40, 50. In one non-limiting embodiment, the solid-state welding process may include an ultrasonic welding process. An ultrasonic welding process is a technique where high-frequency ultrasonic acoustic vibrations are locally applied to workpieces being held together under pressure to create a solid-state weld. This technique may be used to join dissimilar materials as is shown and disclosed herein, wherein the first workpiece 40 may be formed of aluminum and the second workpiece 50 of steel.

The ultrasonic vibrations from the joining tool 36 may he applied to the first or upper surface 42 of the first, workpiece 40. It is contemplated that the material used for the first workpiece 40 of the welding insert 30 will be the same material used for the first panel 12 of the structure 10 while the material used for the second workpiece 50 will be the same material used for the second panel 14 to reduce or eliminate potential reactions between the elements of the welding insert 30 and the first and second panels 12, 14. As previously discussed, the materials used for the workpieces 40, 50 and corresponding first and second panels 12, 14 may vary based upon use and purpose and include metallic or polymeric materials.

At step or box 108, upon completion of the joining process, a portion of the bonded first and second workpieces 40, 50 is separated from the workpieces 40, 50 to create at least one welding insert 30 with a cutting tool or the like and sized to be received between the first and second panels 12, 14. In one non-limiting embodiment, the at least one welding insert 30 is created by cutting the joined workpieces 40, 50 into two or more sections.

At step or box 110, a welding device 28 is provided and cooperates with the first and second panels 12, 14 to assist in joining the first and second panels 12, 14 using the welding insert 30. A portion of an exemplary welding device 28 is illustrated in FIG. 1. In one non-limiting embodiment, welding device 28 may be a resistance spot welder (RSW) or RSW gun that is part of an automated welding operation. Welding device 28 may include a first and second arms (not shown) that are mechanically and electrically configured to repeatedly form spot welds in accordance with a defined weld schedule. The first arm of the welding device 28 may include a first electrode holder 25 that retains a first welding electrode 24, and the second arm may include a second electrode holder 27 that retains a second electrode 26. It is contemplated that the first and second electrodes 24, 26 may be formed of a variety of materials, including, but not limited to, steel, aluminum and the like.

At step or box 112, first and second panels 12, 14 of the structure 10 are positioned relative to the welding device 28. In one embodiment, the first and second arms of the welding device 28 are operable to position the respective first and second electrodes 24, 26 proximate the oppositely-facing exterior and electrode-contacting surfaces 16, 20 of the first and second panels 12, 14.

At step or box 114, the at least one welding insert 30 is positioned between the lower or second surface 18 of the first panel 12 and the upper or first surface 22 of the second panel 14. The welding insert 30 is positioned such that the upper portion 32 of the insert 30 created from the first workpiece 40 and formed from the same material as the first panel 12 is disposed adjacent the lower surface 18 of the first panel 12 while the lower portion 34 of the insert 30 created from the second workpiece and formed from the same material as the second panel 14 is disposed adjacent the upper surface 22 of the second panel 14.

The welding device 28 is positioned adjacent the first and second panels 12, 14 formed of dissimilar materials to join the first and second panels 12, 14 together through the use of the at least one welding insert 30. It is contemplated that the welding device 28 may be utilized to adhere the first and second panels 12, 14 using one or more welding inserts 30 at one or more positions to complete the joining process.

At block or step 116, the first and second welding electrodes 24, 26 may be pressed or clamped against their respective electrode-contacting surfaces 16, 20 of the first and second panels 12, 14 in diametric alignment with one another. The gap or distance between the electrodes 24, 26 may be adjusted. Alternatively, the clamping load or force applied by the electrodes 24, 26 may be adjusted to compensate for the type of materials used for at least one of the first panel 12, second panel 14 and/or the welding insert 30. For example, it is contemplated that a specified gap or clamping force or control may be desired in addition to control of the temperature, amount of time, or level of current to ensure proper joining of the welding insert 30 with the first and second panels 12, 14.

At block or step 118, the welding device 28 generates an electric current with and is conducted through the first and second electrodes 24, 26 and is applied to the first and second panels 12, 14. In one non-limiting example, an adjustable power source is in electrical communication with the welding device 28 to generate current to be passed between the first and second electrodes 24, 26. The welding device 28 may further include a controller (not shown) in electrical communication with an adjustable power source and the first and second electrodes 24, 26 and configured to adjust the current applied by the electrodes 24, 26 to the first and second panels 12, 14.

The first and second electrodes 24, 26 may concentrate the current proximate the location of the at least one welding insert 30 between and relative to the first and second panels 12, 14. The current created by the first and second electrodes 24, 26 generates thermal energy or heat of at least a first temperature that interacts with the welding insert 30 disposed between the first and second panels 12, 14 to bond or fuse the first and second panels 12, 14 together at the position of the welding insert 30 on the structure 10.

The current generated with the first and second electrodes 24, 26 may be applied for a selected time and temperature in order to permit the joining to occur without excessive heating to the first and second panels 12, 14 of the structure 10. The amount of heat or thermal energy delivered may be determined by the resistance between the first and second electrodes 24, 26 and the amperage and duration of the welding current.

The amount of thermal energy and/or duration of the current is chosen to match the material properties and thicknesses of the welding insert 30, the first panel 12 and the second panel 14 as well as the types of electrodes used. A controller (not shown) may be utilized to adjust one or more of the time, current and temperature of the thermal energy used in the joining process. At step or box 120, the welding device 28 is moved away from the first and second panels 12, 14 to complete the joining process between the first panel 12, the welding insert 30 and the second panel 14.

The detailed description and the drawings or figures are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

1. A method of joining a structure having a first panel formed of a first materials and a second panel formed of a second material, the method comprising:
positioning a first workpiece formed of the first material adjacent a second workpiece formed of the second material;
applying a joining process to join the first workpiece to the second workpiece;
preparing at least one welding insert from the joined first and second workpieces, wherein the at least one welding insert includes an upper portion formed of the first material and a lower portion formed of the second material;
positioning the at least one welding insert between the first panel formed of the first material and the second panel formed of the second material, wherein the upper portion of the at least one welding insert is positioned adjacent the first panel and the lower portion of the at least one welding insert is positioned adjacent the second panel;
positioning the first panel, second panel, and at least one welding insert between first and second electrodes of a welding device such that the first electrode is proximate the first panel and the second electrode is proximate the second panel; and
generating an electric current with the first and second electrodes to join the first panel, at least one welding insert and the second panel,
wherein the electric current generates thermal energy having a first temperature that joins the upper portion of the at least one welding insert to the first panel and the lower portion of the at least one welding insert to the second panel to join the first panel with the second panel.

2. The method of claim 1 further comprising:
contacting the first panel with the first electrode and the second panel with the second electrode; and
applying a force to at least one of the first and second electrodes that is operative to clamp the first panel, at least one welding insert, and second panel between the first and second electrodes.

3. The method of claim 1 further comprising preparing the at least one welding insert by cutting the joined first and second workpieces into two or more sections.

4. The method of claim 1 wherein the first material is a metal and the second material is a non-metal.

5. The method of claim 1 wherein the first material is a first metal and the second material is a second metal distinct from the first metal.

6. The method of claim 5 wherein the first metal is steel and the second metal is aluminum.

7. The method of claim 1 wherein the thermal energy is generated between the first and second electrodes of the welding device at a first temperature.

8. The method of claim 7 wherein the first temperature of the thermal energy generated between the first and second electrodes of the welding device is determined based upon the first and second materials used to form the first panel, the second panel, and the at least one welding insert.

9. The method of claim 1 wherein the welding device further comprises a resistance spot welding gun.

10. The method of claim 1 wherein the first and second workpieces are joined using a solid-state welding process.

11. A method of j oining a first panel formed of a first materials and a second panel formed of a second material, the method comprising:
positioning a first workpiece formed of the first material adjacent a second workpiece formed of the second material;
applying a solid-state welding process to join the first workpiece to the second workpiece;
preparing at least one welding insert by separating the joined first and second workpieces into two or more sections, wherein the at least one welding insert includes an upper portion formed of the first material and a lower portion formed of the second material;
positioning the at least one welding insert between the first panel formed of the first material and the second panel formed of the second material, wherein the upper portion of the at least one welding insert is positioned adjacent the first panel and the lower portion of the at least one welding insert is positioned adjacent the second panel;
positioning the first panel, second panel and at least one welding insert between first and second electrodes of a welding device such that the first electrode is proximate the first panel and the second electrode is proximate the second panel; and
generating an electric current with the first and second electrodes to join the first panel, at least one welding insert and the second panel,
wherein the electric current generates thermal energy having a first temperature that joins the upper portion of the at least one welding insert to the first panel and the lower portion of the at least one welding insert to the second panel to join the first panel with the second panel.

12. The method of claim 11 further comprising:
contacting the first panel with the first electrode and the second panel with the second electrode; and
applying a force to at least one of the first and second electrodes that is operative to clamp the first panel, at least one welding insert, and second panel between the first and second electrodes.

13. The method of claim 11 wherein the thermal energy is generated between the first and second electrodes of the welding device at a first temperature, wherein the first temperature of the thermal energy generated between the first and second electrodes of the welding device is determined based upon the first and second materials used to form the first panel, the second panel, and the at least one welding insert.

14. The method of claim 11 further comprising the step of preparing the at least one welding insert by cutting the joined first and second workpieces into two or more sections.

15. The method of claim 11 wherein the first material is steel and the second material is aluminum.

16. A system for assembling a structure comprising:
a first panel formed from a first material;
a second panel made of a second material;
at least one welding insert positionable between and proximate each of the first panel and the second panel, the at least one welding insert including an upper portion formed of the first material and a lower portion formed of the second material; and
a welding device having at least a first electrode and a second electrode configured to join the first panel, second panel, and at least one welding insert between the first and second electrodes to bond the first panel with the second panel,
wherein the welding device,
positions the first panel, second panel, and at least one welding insert between the first and second electrodes such that the first electrode is proximate the first panel and the second electrode is proximate the second panel,
contacts the first panel with the first electrode and the second panel with the second electrode, and
generates an electric current with the first and second electrodes to generate thermal energy having a first temperature that joins the first panel, at least one welding insert, and second panel positioned between the first and second electrodes to bond the first panel with the second panel.

17. The system of claim 16 wherein the first and second electrodes are operatively connected to apply a force to the first panel and the second panel when positioned between the first and second electrodes.

18. The system of claim 16 wherein the thermal energy is generated between the first and second electrodes of the welding device at a first temperature, wherein the first temperature of the thermal energy generated between the first and second electrodes of the welding device is determined based upon one or more of the materials used to form the first panel and the second panel.

19. The system of claim 16 wherein the at least one welding insert is formed by:
applying a joining process to join the upper and lower portions; and
preparing at least one welding insert by separating the joined first and second workpieces into two or more sections, wherein the at least one welding insert includes an upper portion formed of the first material and a lower portion formed of the second material.

20. The system of claim 19 wherein the joining process further comprises a solid-state welding process.
